(19) United States
(12) Patent Application Publication
(10) Pub. No.: US 2022/0391025 A1
(43) Pub. Date: Dec. 8, 2022

(54) DISPLAY SYSTEM, DISPLAY PANEL CONTROL CHIP THEREOF AND RELATED SIGNAL TRANSMISSION SWITCHING METHOD

(71) Applicant: Realtek Semiconductor Corporation, Hsinchu (TW)

(72) Inventors: Yuh-Wey LIN, Hsinchu (TW); Chun-Hao HUANG, Hsinchu (TW)

(21) Appl. No.: 17/645,059

(22) Filed: Dec. 20, 2021

(30) Foreign Application Priority Data
Jun. 8, 2021 (TW) 110120844

(51) Int. Cl. G06F 3/033; G09G 5/14

(52) U.S. Cl. CPC G06F 3/033; G09G 5/14; G09G 2370/20; G09G 2354/00; G06F 13/4282

(57) ABSTRACT

A display panel control chip including a processor and a signal processing circuit is provided. The processor controls a display panel to display first and second images corresponding to first and second video signals. The first image is adjacent to the second image by a border extending in perpendicular to a first direction at a first coordinate. The signal processing circuit stores the first coordinate, determines whether a first cursor is in the first image or the second image according to a cursor control signal and the first coordinate, and transmits, according to the determination, the cursor control signal to either a signal source of the first video signal or a signal source of the second video signal. When an area ratio of the first image to the second image is changed, the processor controls the signal processing circuit to update the first coordinate.

### RELATED APPLICATIONS

This application claims priority to Taiwan Application Serial Number 110120844, filed on Jun. 8, 2021, which is herein incorporated by reference in its entirety.

### BACKGROUND

### Technical Field

The present disclosure relates to a display system, a display panel control chip and a related driving method. More particularly, the present disclosure relates to a display system and a display panel control chip capable of automatically switching signal transmission paths and to a related signal transmission switching method.

### Description of Related Art

With the popularity of large-size home-use displays, users can display multimedia content from different sources on the same display nowadays, thereby improving user experience and expanding the use of displays. For example, when the left-side of the display shows a computer game executed on a desktop computer, the right-side of the display can show a browser executed on a laptop for searching game guides. However, in order to control different computers, the desktop of a user usually occupied by multiple sets of keyboards and mice, decreasing the efficiency of space utilization. Moreover, switching between the sets of keyboards and mice would reduce the work efficiency of the user.

### SUMMARY

The disclosure provides a display panel control chip including a processor and a signal processing circuit. The processor is configured to control a display panel to display a first image and a second image corresponding to a first video signal and a second video signal, respectively. The first image is adjacent to the second image by a border extending in perpendicular to a first direction at a first coordinate in the first direction. The signal processing circuit is configured to store the first coordinate, and configured to determine whether a first cursor is in the first image or the second image at least according to a first cursor control signal and the first coordinate to generate a first determination result. The signal processing circuit is further configured to transmit, according to the first determination result, the first cursor control signal to either a first signal source of the first video signal or a second signal source of the second video signal. In response to that an area ratio of the first image to the second image is changed, the processor controls the signal processing circuit to update the first coordinate.

The disclosure provides a signal transmission switching method applicable to a display panel control chip. The method includes the following operations: controlling a display panel to display a first image and a second image corresponding to a first video signal and a second video signal, respectively, in which the first image is adjacent to the second image by a border extending in perpendicular to a first direction at a first coordinate in the first direction; determining whether a first cursor is in the first image or the second image at least according to a first cursor control signal and the first coordinate to generate a first determination result; transmitting, according to the first determination result, the first cursor control signal to either a first signal source of the first video signal or a second signal source of the second video signal; and in response to that an area ratio of the first image to the second image is changed, updating the first coordinate stored in the display panel control chip.

The disclosure provides a display system including a display panel and a display panel control chip coupled with the display panel. The display panel control chip includes a processor and a signal processing circuit. The processor is configured to control the display panel to display a first image and a second image corresponding to a first video signal and a second video signal, respectively. The first image is adjacent to the second image by a border extending in perpendicular to a first direction at a first coordinate in the first direction. The signal processing circuit is configured to store the first coordinate, and configured to determine whether a first cursor is in the first image or the second image at least according to a first cursor control signal and the first coordinate to generate a first determination result. The signal processing circuit is further configured to transmit, according to the first determination result, the first cursor control signal to either a first signal source of the first video signal or a second signal source of the second video signal. In response to that an area ratio of the first image to the second image is changed, the processor controls the signal processing circuit to update the first coordinate.

It is to be understood that both the foregoing general description and the following detailed description are by examples, and are intended to provide further explanation of the disclosure as claimed.

### BRIEF DESCRIPTION OF THE DRAWINGS

FIG. 1 is a simplified functional block diagram of a display system according to one embodiment of the present disclosure.

FIG. 2A is a schematic diagram for illustrating movement of a cursor in the image of a display panel.

FIG. 2B is a schematic diagram for illustrating an operation performed by the processor to adjust the area ratio of the images.

FIG. 3A is a schematic diagram for illustrating movement of the cursor in the image of the display panel.

FIG. 3B is a schematic diagram for illustrating an operation performed by the processor to adjust the area ratio of the images.

FIG. 4 is a simplified functional block diagram of a display system 400 according to one embodiment of the present disclosure.

FIG. 5 is a schematic diagram for illustrating movement of the cursor in the image of the display panel.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

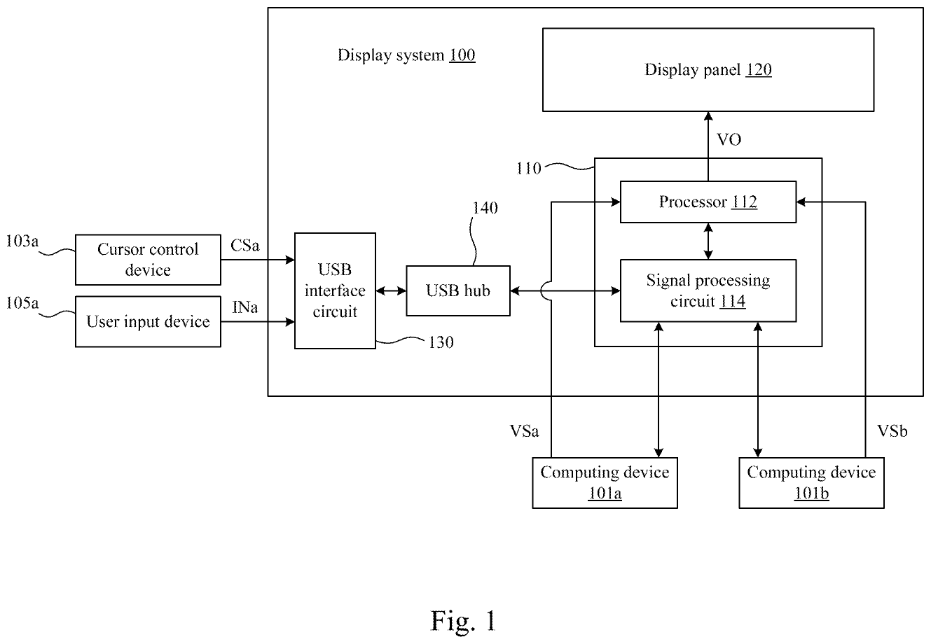

FIG. 1 is a simplified functional block diagram of a display system 100 according to one embodiment of the present disclosure. The display system 100 comprises a display panel control chip 110, a display panel 120, a universal serial bus (USB) interface circuit 130 and a USB hub 140. The display panel control chip 110 is coupled with the USB interface circuit 130 through the USB hub 140, and also coupled with the display panel 120.

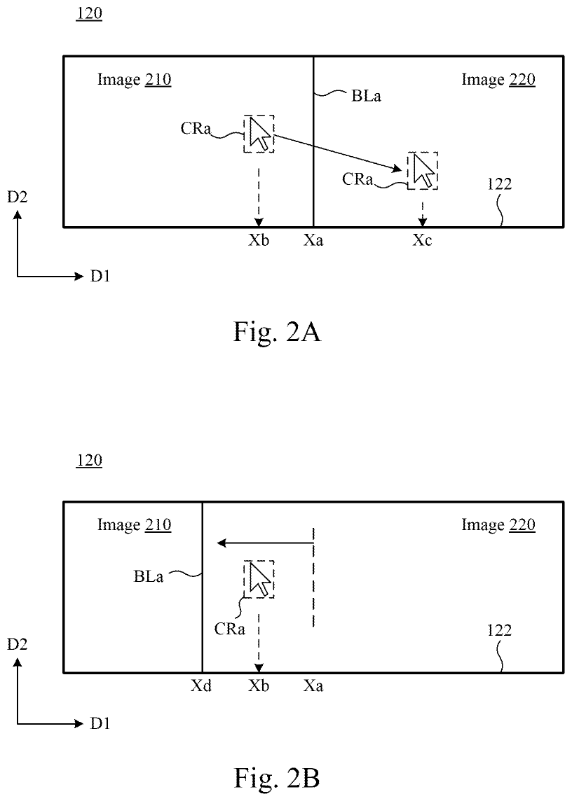

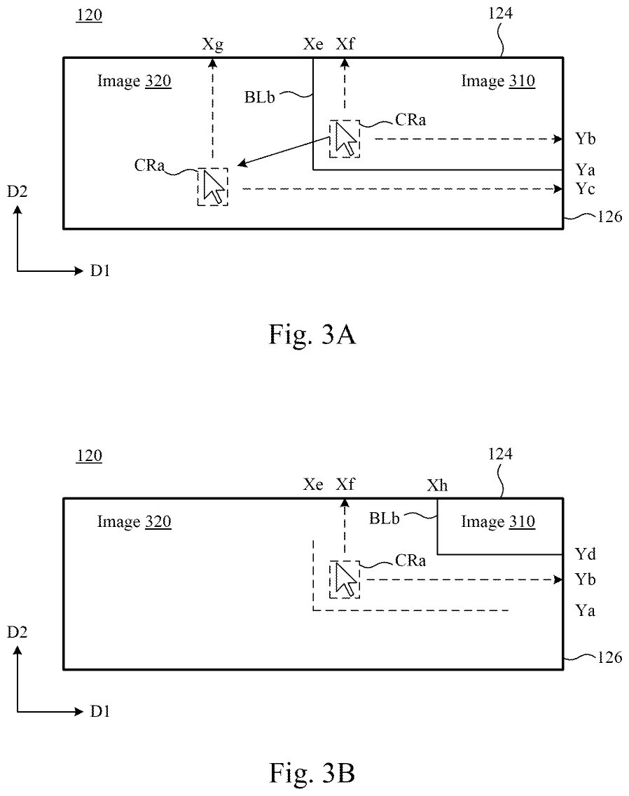

The display panel control chip 110 comprises a processor 112 and a signal processing circuit 114 coupled with each other. When the display system 100 receives a plurality of video signals VSa and VSb from a plurality of computing devices 101a and 101b, the processor 112 generates a video output VO according to contents of the video signals VSa and VSb. The processor 112 controls the display panel 120 by the video output VO to simultaneously display a plurality of images corresponding to the contents of the video signals VSa and VSb, respectively. For example, as shown in the later-described FIG. 2A, the processor 112 may control the display panel 120 to simultaneously display picture-by-picture images 210 and 220, which correspond to the video signals VSa and VSb, respectively. As another example, as shown in the later-described FIG. 3A, the processor 112 may control the display panel 120 to simultaneously display picture-in-picture images 310 and 320, which correspond to the video signals VSa and VSb, respectively.

In some embodiments, the display panel control chip 110 may be implemented by a scaler integrated circuit (IC). Therefore, the process that the processor 112 generates the video output VO according to the video signals VSa and VSb comprises an operation of adjusting the resolution of the contents of the video signals VSa and VSb.

In practice, the processor 112 may encapsulate packets of a frame of the video signal VSa and packets of a frame of the video signal VSb into packets of a frame of the video output VO, and then transmits the packets of the video output VO to the display panel 120. As a result, the display panel 120 is capable of simultaneously displaying images corresponding to the video signals VSa and VSb in a frame. In other embodiments, each of the computing devices 101a and 101b may be implemented by a desktop computer, a laptop or a game console.

Reference is made again to FIG. 1. When the display system 100 is coupled with a cursor control device 103a, the signal processing circuit 114 receives a cursor control signal CSa of the cursor control device 103a through the USB interface circuit 130 and the USB hub 140. In some embodiments, the cursor control device 103a may be implemented by a mouse, a trackball or a joystick. Packets of the cursor control signal CSa may comprise information of buttons that are pushed and information of cursor movement amount. In some embodiments, the signal processing circuit 114 may calculate a current coordinate of a cursor CRa according to the information of cursor movement amount, and controls the processor 112 to display, by the video output VO, the cursor CRa at a proper location of the display panel 120. In some embodiments, the signal processing circuit 114 may be implemented by a USB host.

In addition, the signal processing circuit 114 transmits the cursor control signal CSa to one of the computing devices 101a and 101b, according to the current coordinate of the cursor CRa, which is described in detail in the following paragraphs. In some embodiments, the signal processing circuit 114 is further coupled with a user input device 105a through the USB interface circuit 130 and the USB hub 140. A user input signal INa of the user input device 105a and the cursor control signal CSa are transmitted to the same target. In some embodiments, the user input device 105a may be implemented by a keyboard. Notably, each of the cursor control signal CSa and the user input signal INa is not transmitted to the computing device 101a or the computing device 101b before being transmitted to the signal processing circuit 114.

An operation of switching signal transmission paths performed by the display panel control chip 110 is described below with reference to FIG. 2A and FIG. 2B. FIG. 2A is a schematic diagram for illustrating movement of the cursor CRa in the image of the display panel 120. As shown in FIG. 2A, the display panel 120 displays, according to the video output VO, picture-by-picture images 210 and 220 corresponding to the video signals VSa and VSb, respectively, in which the image 210 is adjacent to the image 220 by a border BLa. Notably, the border BLa needs not to be a line actually displayed by the display panel 120. The border BLa is used to represent an edge where the images 210 and 220 connect to each other.

In this embodiment, the display panel 120 comprises an edge 122 extends along a first direction D1. The border BLa extends in perpendicular to the first direction D1 at a coordinate Xa in the first direction D1 (herein after referred to as “the border BLa has the coordinate Xa in the first direction D1”). The coordinate Xa is stored in the signal processing circuit 114. The coordinate Xa may be stored in the signal processing circuit 114 in advanced when the display system 100 is fabricated; or the coordinate Xa may be transmitted to the signal processing circuit 114 by the processor 112 after the processor 112 determines an area ratio of the image 210 to image 220.

The signal processing circuit 114 determines whether the cursor CRa is in the image 210 or the image 220 according to the cursor control signal CSa and the coordinate Xa to generate a determination result. The signal processing circuit 114 transmits, according to such determination result, the cursor control signal CSa and/or the user input signal INa to a corresponding one of the computing devices 101a and 101b.

At a time point, for example, the signal processing circuit 114 calculates that the cursor CRa has a coordinate Xb in the first direction D1 according to the cursor control signal CSa. The signal processing circuit 114 further determines that the cursor CRa is in the image 210 according to a difference between the coordinates Xa and Xb (e.g., the relative magnitude). Since the image 210 is generated based on the video signal VSa, the signal processing circuit 114 transmits the cursor control signal CSa and/or the user input signal INa to the signal source of the video signal VSa, that is, the computing device 101a. As a result, the user can controls the computing device 101a by the cursor control device 103a and/or the user input device 105a.

At another time point, the signal processing circuit 114 calculates, according to the cursor control signal CSa, that the cursor CRa is moved to another position and has a coordinate Xc in the first direction D1. The signal processing circuit 114 further determines that the cursor CRa is in the image 220 according to the difference between the coordinates Xa and Xc (e.g., the relative magnitude). In this situation, the signal processing circuit 114 transmits the cursor control signal CSa and/or the user input signal INa to the signal source of the video signal VSb, that is, the computing device 101b to allow the user to control the computing device 101b by the cursor control device 103a and/or the user input device 105a.

FIG. 2B is a schematic diagram for illustrating an operation performed by the processor 112 to adjust the area ratio of the image 210 to image 220. In this embodiment, the processor 112 may change the area ratio of the image 210 to image 220 (e.g., from 1:1 of FIG. 2A to 1:3 of FIG. 2B), and the coordinate of the border BLa in the first direction D1 may be changed accordingly. In some embodiments, the processor 112 is configured to receive a user command of adjusting the area ratio of the image 210 to image 220 from a push button (not shown) of the display system 100, but this disclosure is not limited thereto. When the processor 112 changes the area ratio of the image 210 to image 220, the processor 112 controls the signal processing circuit 114 to update the stored coordinate of the border BLa in the first direction D1. In this situation, the signal processing circuit 114 may determines, according to the position of the cursor CRa, whether to switch the signal transmission paths of the cursor control signal CSa and/or the user input signal INa.

For example, as shown in FIG. 2B, when the border BLa is changed from having the coordinate Xa to having the coordinate Xd in the first direction D1, the processor 112 controls the signal processing circuit 114 to update the stored coordinate of the border BLa (i.e., to update the coordinate Xa to the coordinate Xd).

As shown in FIG. 2B, before the change of the area ratio of the image 210 to image 220, the cursor CRa has the coordinate Xb in the first direction D1 and is in the image 210. Therefore, the signal processing circuit 114 transmits the cursor control signal CSa and/or the user input signal INa to the computing device 101a.

After the change of the area ratio of the image 210 to image 220, although the position of the cursor CRa remains the same, the signal processing circuit 114 determines that the cursor CRa is in the image 220 by comparing the coordinates Xd with the coordinate Xb. Therefore, the signal processing circuit 114 transmits the cursor control signal CSa and/or the user input signal INa to the computing device 101b.

Another operation performed by the display panel control chip 110 to switch the signal transmission paths is described below with reference to FIG. 3A and FIG. 3B. FIG. 3A is a schematic diagram for illustrating movement of the cursor CRa in the image of the display panel 120. As shown in FIG. 3A, the display panel 120 displays, according to the video output VO, picture-in-picture images 310 and 320 corresponding to the video signals VSa and VSb, respectively, in which the image 310 is adjacent to the image 320 by a border BLb. Notably, the border BLb needs not to be a line actually displayed by the display panel 120. The border BLb is used to represent an edge where the images 310 and 320 connect to each other.

In this embodiment, the display panel 120 comprise an edge 124 extends along the first direction D1, and also comprise an edge 126 extend along the second direction D2, in which the first direction D1 is different from the second direction D2. The border BLb extends in perpendicular to the first direction D1 at a coordinate Xe in the first direction D1, and also extends in perpendicular to the second direction D2 at a coordinate Ya in the second direction D2 (hereinafter refer to as “the border BLb has the coordinates Xe and Ya in the first direction D1 and the second direction D2, respectively”). The signal processing circuit 114 stores the coordinates Xe and Ya of the border BLb. The coordinates Xe and Ya may be stored in the signal processing circuit 114 in advanced when the display system 100 is fabricated; or the coordinates Xe and Ya may be transmitted to the signal processing circuit 114 by the processor 112 after the processor 112 determines an area ratio of the image 310 to image 320.

The signal processing circuit 114 determines whether the cursor CRa is in the image 310 or image 320 according to the cursor control signal CSa, the coordinate Xe, and the coordinate Ya to generate a determination result. The signal processing circuit 114 transmits, according to such determination result, the cursor control signal CSa to a corresponding one of the computing devices 101a and 101b.

At a time point, for example, the signal processing circuit 114 calculates that the cursor CRa has a coordinate Xf in the first direction D1 and a coordinate Yb in the second direction D2 according to the cursor control signal CSa. The signal processing circuit 114 further determines that the cursor CRa is in the image 310 according to the difference between the coordinates Xe and Xf and the difference between the coordinates Ya and Yb (e.g., the relative magnitude). Since the image 310 is generated based on the video signal VSa, the signal processing circuit 114 transmits the cursor control signal CSa and/or the user input signal INa to the computing device 101a. As a result, the user can control the computing device 101a by the cursor control device 103a and/or the user input device 105a.

At another time point, the signal processing circuit 114 calculates, according to the cursor control signal CSa, that the cursor CRa is moved to another position and has a coordinate Xg in the first direction D1 and a coordinate Yc in the second direction D2. The signal processing circuit 114 further determines the cursor CRa is in the image 320 according to the difference between the coordinates Xe and Xg and the difference between the coordinates Ya and Yc (e.g., the relative magnitude). In this situation, the signal processing circuit 114 transmits the cursor control signal CSa and/or the user input signal INa to the computing device 101b to allow the user to control the computing device 101b by the cursor control device 103a and/or the user input device 105a.

FIG. 3B is a schematic diagram for illustrating an operation performed by the processor 112 to adjust the area ratio of the image 310 to image 320. When the processor 112 changes the area ratio of the image 310 to image 320, the coordinates of the border BLb in the first direction D1 and the second direction D2 are changed accordingly. When the processor 112 changes the area ratio of the image 310 to image 320, the processor 112 controls the signal processing circuit 114 to update the stored coordinates of the border BLb. In this situation, the signal processing circuit 114 may determine whether to switch the signal transmission paths of the cursor control signal CSa and/or the user input signal INa according to the position of the cursor CRa.

For example, when the border BLb is changed from having the coordinate Xe to having the coordinate Xh in the first direction D1 and from having the coordinate Ya to having the coordinate Yd in the second direction D2, the processor 112 controls the signal processing circuit 114 to update the stored coordinates Xe and Ya to the coordinates Xh and Yd, respectively.

As shown in FIG. 3B, before the change of the area ratio of the image 310 to image 320, the cursor CRa has coordinates Xf and Yb and is in the image 310. Therefore, the signal processing circuit 114 transmits the cursor control signal CSa and/or the user input signal INa to the computing device 101a. After the change of the area ratio of the image 310 to image 320, although the position of the cursor CRa remains the same, the signal processing circuit 114 determines that the cursor CRa is in the image 320 by comparing the coordinate Xf with the coordinate Xh and comparing the coordinate Yd with the coordinate Yb. Therefore, the signal processing circuit 114 transmits the cursor control signal CSa and/or the user input signal INa to the computing device 101b.

As can be appreciated from the above, the display system 100 allows a one-to-many control by the user through a set of input device, which improves the efficiency of space utilization of the desktop. Moreover, when the area ratio of images are changed, the display system 100 can automatically update the conditions used to switch between the control targets (e.g., the computing devices 101a and 101b) and needs not to rely on the help from the control targets; therefore, the computing resources of the control targets would not be occupied.

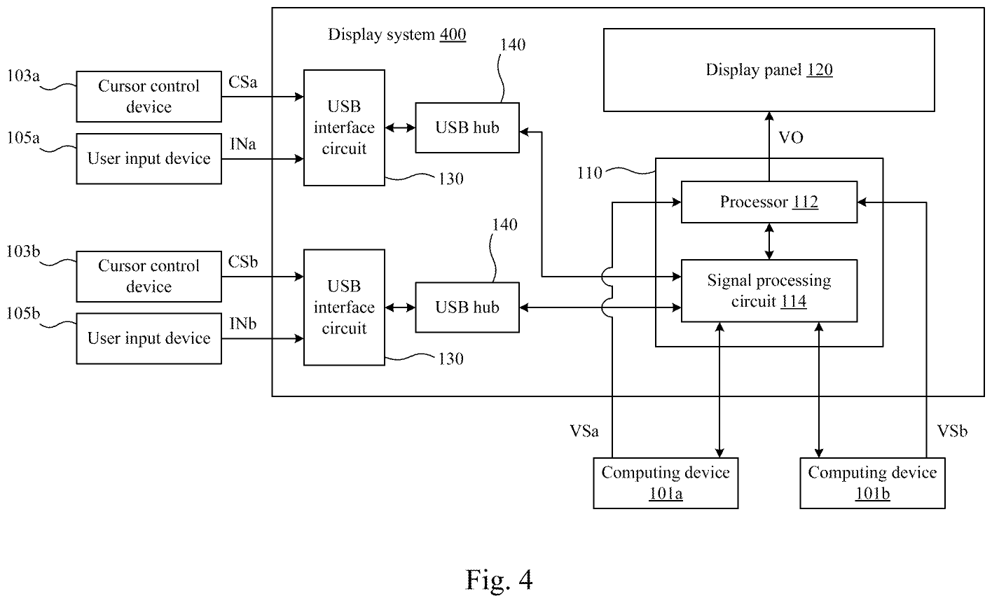

FIG. 4 is a simplified functional block diagram of a display system 400 according to one embodiment of the present disclosure. The display system 400 is similar to the display system 100, and the difference is that the display system 400 has a plurality of USB interface circuits 130 and a plurality of USB hubs 140. For the sake of brevity, only two sets of the USB interface circuits 130 and the USB hubs 140 are depicted in FIG. 4, but this disclosure is not limited thereto.

In this embodiment, the display system 400 is coupled with cursor control devices 103a and 103b though the USB interface circuits 130 and the USB hubs 140, so as to receive cursor control signals CSa and CSb from the cursor control devices 103a and 103b, respectively. The signal processing circuit 114 may calculates current coordinates of the cursors CRa and CRb according to the cursor control signals CSa and CSb, respectively, and may control the processor 112 to display, by the video output VO, the cursors CRa and CRb at suitable positions of the display panel 120.

In addition, the signal processing circuit 114 transmits the cursor control signal CSa to one of the computing devices 101a and 101b according to the current coordinate of the cursor CRa. Similarly, the cursor control signal CSb is transmitted to a corresponding one of the computing devices 101a and 101b because of the current coordinate of the cursor CRb, which is described in detail in the following paragraphs. In some embodiments, the signal processing circuit 114 is further coupled to user input devices 105a and 105b through the USB interface circuit 130. A user input signal INa of the user input device 105a and the cursor control signal CSa are transmitted to the same target, and a user input signal INb of the user input device 105b and the cursor control signal CSb are transmitted to the same target.

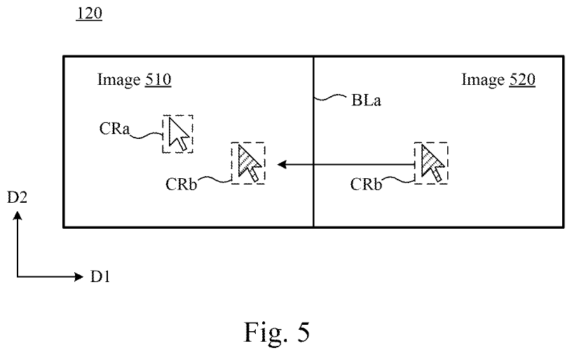

An operation of switching signal transmission paths performed by the display panel control chip 410 is described below with reference to FIG. 5. FIG. 5 is a schematic diagram for illustrating movement of the cursor CRb in the image of the display panel 120. As shown in FIG. 5, the display panel 120 displays, according to the video output VO, picture-by-picture images 510 and 520 corresponding to the video signals VSa and VSb, respectively, in which the image 510 is adjacent to the image 520 by the border BLa.

At a time point, the signal processing circuit 114 determines that the cursor CRa is in the image 510 according to the cursor control signal CSa (i.e., the coordinate of the cursor CRa in the first direction D1) and the coordinate of the border BLa in the first direction D1. The signal processing circuit 114 further determines that the cursor CRb is in the image 520 according to the cursor control signal CSb (i.e., the coordinate of the cursor CRb in the first direction D1) and the coordinate of the border BLa in the first direction D1. Therefore, the signal processing circuit 114 transmits the cursor control signal CSa and/or the user input signal INa to the computing device 101a, and transmits the cursor control signal CSb and/or the user input signal INb to the computing device 101b.

At another time point, the signal processing circuit 114 determines that the cursor CRb is moved from the image 520 to the image 510, according to the cursor control signal CSb (i.e., the coordinate of the cursor CRb in the first direction D1) and the coordinate of the border BLa in the first direction D1. In this situation, the signal processing circuit 114 transmits the cursor control signal CSa and/or the user input signal INa and also the cursor control signal CSb and/or the user input signal INb to the computing device 101a. As a result, different users can cooperatively control the computing device 101a through respective input devices (e.g., the keyboard and the mouse) without the need of interchanging their input devices, which allows the users to quickly assist each other at work.

In some embodiments that the display system 400 provides picture-in-picture images, the display system 400 may transmits the cursor control signals CSa and CSb to the same target or to different targets, respectively, according to the cursor control signals CSa and CSb and also to coordinates, in the first direction D1 and the second direction D2, of a border of the picture-in-picture images. The display system 400 may use the method discussed above with reference to FIG. 3A to determine whether the transmission path of any one of the cursor control signals CSa and CSb needs to be switched. For the sake of brevity, those descriptions are omitted.

In some embodiments that the display system 400 can change the area ratio of images, the display system 400 may use one of the methods discussed above with reference to FIG. 2B and FIG. 3B to determine whether the transmission path of any one of the cursor control signals CSa and CSb needs to be switched, according to respective positions of the cursors CRa and CRb. For the sake of brevity, those descriptions are omitted.

The foregoing descriptions regarding to other corresponding implementations, connections, components, and related advantages of the display system 100 are also applicable to the display system 400. For the sake of brevity, those descriptions are omitted.

In some embodiments that the display panel control chip 110 has more input/output pins, the USB hubs 140 of FIG. 1 and FIG. 4 may be omitted.

Certain terms are used throughout the description and the claims to refer to particular components. One skilled in the art appreciates that a component may be referred to as different names. This disclosure does not intend to distinguish between components that differ in name but not in function. In the description and in the claims, the term “comprise” is used in an open-ended fashion, and thus should be interpreted to mean “include, but not limited to.” The term “couple” is intended to compass any indirect or direct connection. Accordingly, if this disclosure mentioned that a first device is coupled with a second device, it means that the first device may be directly or indirectly connected to the second device through electrical connections, wireless communications, optical communications, or other signal connections with/without other intermediate devices or connection means.

The term “and/or” may comprise any and all combinations of one or more of the associated listed items. In addition, the singular forms “a,” “an,” and “the” herein are intended to comprise the plural forms as well, unless the context clearly indicates otherwise.

Other embodiments of the present disclosure will be apparent to those skilled in the art from consideration of the specification and practice of the present disclosure disclosed herein. It is intended that the specification and examples be considered as exemplary only, with a true scope and spirit of the present disclosure being indicated by the following claims.

1. A display panel control chip, comprising:
a processor, configured to control a display panel to display a first image and a second image corresponding to a first video signal and a second video signal, respectively, wherein the first image is adjacent to the second image by a border, wherein the border extends in perpendicular to a first direction at a first coordinate in the first direction and extends in perpendicular to a second direction at a second coordinate in the second direction, and the first direction is different from the second direction; and
a signal processing circuit, configured to store the first coordinate and the second coordinate, configured to determine whether a first cursor is in the first image or the second image according to a first cursor control signal, the first coordinate and the second coordinate to generate a first determination result, and configured to transmit, according to the first determination result, the first cursor control signal to either a first signal source of the first video signal or a second signal source of the second video signal, wherein in response to that an area ratio of the first image to the
second image is changed, the processor controls the signal processing circuit to update the first coordinate and the second coordinate.

2. (canceled)

3. The display panel control chip of claim 1, wherein the signal processing circuit is further configured to transmit, according to the first determination result, a first user input signal different from the first cursor control signal to either the first signal source or the second signal source.

4. The display panel control chip of claim 3, wherein each of the first cursor control signal and the first user input signal is free from being transmitted to the first signal source or the second signal source before being transmitted to the signal processing circuit.

5. The display panel control chip of claim 1, wherein the signal processing circuit is further configured to determine whether a second cursor is in the first image or the second image according to a second cursor control signal, the first coordinate and the second coordinate to generate a second determination result, and configured to transmit, according to the second determination result, the second cursor control signal to either the first signal source or the second signal source.

6. (canceled)

7. The display panel control chip of claim 1, wherein the signal processing circuit is a universal serial bus (USB) host.

8. A signal transmission switching method, applicable to a display panel control chip, comprising:
controlling a display panel to display a first image and a second image corresponding to a first video signal and a second video signal, respectively, wherein the first image is adjacent to the second image by a border, wherein the border extends in perpendicular to a first direction at a first coordinate in the first direction and extends in perpendicular to a second direction at a second coordinate in the second direction, and the first direction is different from the second direction;
determining whether a first cursor is in the first image or the second image according to a first cursor control signal, the first coordinate and the second coordinate to generate a first determination result;
transmitting, according to the first determination result, the first cursor control signal to either a first signal source of the first video signal or a second signal source of the second video signal; and
in response to that an area ratio of the first image to the second image is changed, updating the first coordinate and the second coordinate stored in the display panel control chip.

9. (canceled)

10. The method of claim 8, further comprising:
transmitting, according to the first determination result, a first user input signal different from the first cursor control signal to either the first signal source or the second signal source.

11. The method of claim 10, wherein each of the first cursor control signal and the first user input signal is free from being transmitted to the first signal source or the second signal source before being transmitted to the display panel control chip.

12. The method of claim 8, further comprising:
determining whether a second cursor is in the first image or the second image according to a second cursor control signal, the first coordinate, and the second coordinate to generate a second determination result; and
transmitting, according to the second determination result, the second cursor control signal to either the first signal source or the second signal source.

13. (canceled)

14. The method of claim 8, wherein the display panel control chip is a scaler integrated circuit (IC).

15. A display system, comprising:
a display panel; and
a display panel control chip, coupled with the display panel, and comprising:
a processor, configured to control the display panel to display a first image and a second image corresponding to a first video signal and a second video signal, respectively, wherein the first image is adjacent to the second image by a border, wherein the border extends in perpendicular to a first direction at a first coordinate in the first direction and extends in perpendicular to a second direction at a second coordinate in the second direction, and the first direction is different from the second direction; and
a signal processing circuit, configured to store the first coordinate and the second coordinate, configured to determine whether a first cursor is in the first image or the second image according to a first cursor control signal, the first coordinate and the second coordinate to generate a first determination result, and configured to transmit, according to the first determination result, the first cursor control signal to either a first signal source of the first video signal or a second signal source of the second video signal,
wherein in response to that an area ratio of the first image to the second image is changed, the processor controls the signal processing circuit to update the first coordinate and the second coordinate.

16. (canceled)

17. The display system of claim 15, wherein the signal processing circuit is further configured to transmit, according to the first determination result, a first user input signal different from the first cursor control signal to either the first signal source or the second signal source.

18. The display system of claim 17, wherein each of the first cursor control signal and the first user input signal is free from being transmitted to the first signal source or the second signal source before being transmitted to the signal processing circuit.

19. The display system of claim 15, wherein the signal processing circuit is further configured to determine whether a second cursor is in the first image or the second image at according to a second cursor control signal, the first coordinate and the second coordinate to generate a second determination result, and configured to transmit, according to the second determination result, the second cursor control signal to either the first signal source or the second signal source.

20. (canceled)
